(19) United States
(12) Patent Application Publication
(10) Pub. No.: US 2008/0236986 A1
(43) Pub. Date: Oct. 2, 2008

(54) BRAKE HANDLE

(75) Inventor: Mark Jesse, Hamburg (DE)

Correspondence Address: KELLY LOWRY & KELLEY, LLP, 6320 CANOGA AVENUE, SUITE 1650, WOODLAND HILLS, CA, 91367, US

(73) Assignee: DOLMAR GmbH, Hamburg (DE)

(21) Appl. No.: 11/765,654

(22) Filed: Jun. 20, 2007

(30) Foreign Application Priority Data
Jun. 21, 2006 (DE) DE 202006009817.8

(51) Int. Cl. F16D 65/14; A01D 34/90

(52) U.S. Cl. 192/18 R; 30/216

(57) ABSTRACT

A hand-guided work implement, in particular hedge clippers, is provided which includes a drive having an internal combustion engine for a cutting tool and a handle for a user's hand and at least one other handle at a distance from said one handle for the other hand of the user. A throttle lever is provided on one handle and is capable of being actuated by the user's hand, which controls the power of the drive. At least one brake lever for a starting brake of the cutting tool is provided on the at least one other handle. The starting brake can be adjusted between a brake position and a cutting position.

### TECHNICAL FIELD

The invention relates to a hand-guided work implement, in particular hedge clippers, comprising a drive having an internal combustion engine for a cutting tool and a handle for a user's hand and at least one other handle at a distance from said handle for the other hand of the user and a throttle lever provided on one handle and capable of being actuated by the user's hand, which controls the power of the drive and at least one brake lever for a starting brake of the cutting tool which can be adjusted between a brake position and a cutting position.

### PRIOR ART

Hedge clippers driven by internal combustion engines must have a brake which prevents any undesired starting of the cutting blade during starting of the internal combustion engine which may cause injuries. For this purpose, DE 36 39 650 A1 proposes a combined brake and throttle lever mechanism in the rear pistol handle. The non-actuated brake lever locks the throttle lever in this case and the throttle lever can only be operated after the brake lever has been pressed down and has released the throttle lever.

DE 39 32 137 A1 provides a safety mechanism with throttle lever and drag lever. When starting the appliance, the brake is fixed by a drag lever located on an adjustable locking pin. After starting, the throttle lever is depressed into the full-throttle position whereby the drag lever lifts from the locking pin, this returns to its initial position and the drag lever is thus released.

DE 198 21 697 C2 likewise describes a safety mechanism arranged on the rear pistol handle of a hedge clipper, comprising combined throttle and brake levers, which can both be actuated by a user's hand.

### DESCRIPTION OF THE INVENTION: OBJECT, SOLUTION, ADVANTAGES

It is the object of the invention to provide a hand-guided work implement with another braking mechanism.

The object is achieved by a hand-guided work implement specified initially which has the feature of the characterising part of the main claim.

The starting brake according to the invention which satisfies the valid safety standards makes use of the idea of providing a throttle lever and brake lever on handles spaced apart from one another each for one hand of a user and thus using a handle sequence usual for starting the internal combustion engine. One handle provided with the throttle lever is gripped by one of the user's hands in cutting operation and other handle provided with the brake lever is gripped by the user's other hand. Both levers can be favourably actuated independently of one another and can be continuously freely adjustable in their position. A coupling mechanism between the throttle and brake lever is thus advantageously superfluous.

The work implement according to the invention preferably has a cable starter for starting the internal combustion engine which can be actuated by means of a starter handle to be grasped with the user's other hand. A restoring mechanism which automatically returns the non-actuated at least one brake lever into its braking position is in communication with the brake lever.

During the starting process, the user's other hand which in cutting operation, automatically actuates the at least one brake lever by grasping the other handle and moves this into the cutting position, must release the other handle to grip the starter handle.

During starting and also during cutting operation, however, the user's hand can grasp the one handle.

Along with angle grinders, lawn edge cutters and chain saws, hand-guided work implements are to be understood here in particular as hedge clippers. The at least two handles in total can run along a centre line of the work implement but, for example, can also be arranged perpendicular to the centre line. If there is more than precisely one other handle, each of the other handles can have a brake lever.

The brake lever is preferably connected via a controller to a throttle flap of an internal combustion engine. The controller can be configured in the form of a control cable, a Bowden cable or similar and can control the angular position of the throttle flap in the air/gas mixture supply to the internal combustion engine.

The restoring mechanism for the at least one brake lever is preferably configured as a restoring spring provided in the other handle or as a brake cable tensioned in the cutting position. It advantageously pulls on the starting brake during starting or after unintentional release of the at least one brake lever. The brake lever is connected to the starting brake by means of a brake controller. The brake controller can be configured as a brake cable, Bowden cable or similar. The brake cable is preferably protected in a cable guide.

In a preferred embodiment of the invention, the one brake lever is constructed as elongated and runs along the at least one other handle and projects from the at least one other handle in the braking position whilst in the cutting position it is lowered in a receptacle of the at least one other handle against a restoring force of the restoring mechanism. It there forms part of an overall smooth handle surface and the user can thus hold the work implement comfortably over fairly long operating times.

In a particularly durable embodiment of the invention, the at least one elongated brake lever is connected to the handle via precisely one joint.

The handle is most preferably provided on the outside on the side of the drive facing away from the cutting tool and the at least one other handle is provided on the side of the drive facing the cutting tool, preferably in an approximately central section along a centre line of the work implement. The arrangement of the handles along the centre line allows these to be spaced far apart from one another and therefore allows associated slight pivoting movements despite small external overall dimensions.

Preferably in single-sided hedge clippers in a plan view from a user's perspective onto the cutting tool during the cutting operation, the at least one other handle is provided substantially completely to the side adjacent to the cutting tool and approximately centrally along the central line of the work implement and is arranged substantially parallel to the precisely one rear handle. When the lateral handle in said plan view is arranged on the right of the cutting tool, the hedge clipper is ergonomically particularly well suited for handling by right-handed persons and conversely. In both cases, the user holds the hedge cutter transversely in front of them.

At its end facing the cutting tool the lateral front handle preferably has a hand protector in the form of a guard plate which is most preferably bent away from the cutting tool and thus protects the user's other hand particularly well.

In another embodiment of the invention which is particularly suitable for double-sided hedge clippers, in a plan view from the usual user's perspective during the cutting operation, the front handle is arranged perpendicularly to the central line substantially centrally over the cutting tool. It can be configured particularly stably as a bow with both its ends connected to a frame. The rear handle is then preferably aligned along the centre line. The arrangement of the two handles perpendicular to one another is economically particularly favourable for double-sided operation. The hedge clippers are held by the user perpendicularly in front of him and can thus be used in left and right pivoting movements.

The frame, the lateral handle and the bow can cost-effectively be tube sections, preferably sections of a one-piece frame tube.

In a further development of the invention, in particular for hedge clippers, the bow and the lateral handle can preferably be mounted as desired. The rear handle then most preferably has a pivoting mechanism in order to adopt an ergonomically favourable handle position, parallel or perpendicular to one another, for single-sided or double-sided hedge cutters. Both the bow and the lateral handles have a brake lever in this case, the relevant brake controller being detachably connectable to the starting brake in each case.

### BRIEF DESCRIPTION OF THE DRAWINGS

The invention is described with reference to two exemplary embodiments in seven figures. In the purely schematic diagrams in the figures:

FIG. 1 is a perspective view of a first embodiment of a handle-gear unit of a hedge clipper according to the invention,

FIG. 2 is a side view in FIG. 1,

FIG. 3 is a plan view in FIG. 1,

FIG. 4 is a sectional view along the line IV-IV in FIG. 3,

FIG. 5 is a perspective view of a second embodiment of a handle-gear unit of a hedge clipper according to the invention,

FIG. 6 is a side view in FIG. 5, and

FIG. 7 is a plan view in FIG. 5.

### BEST MODE FOR IMPLEMENTING THE INVENTION

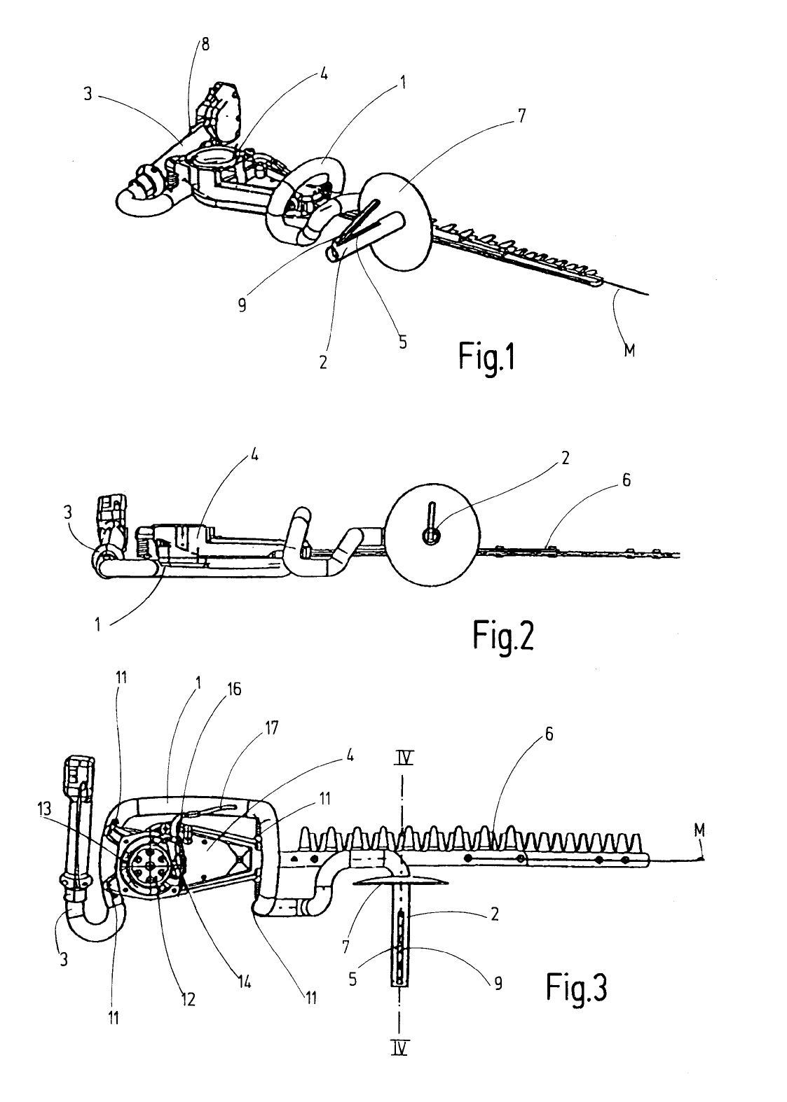

FIG. 1 shows a part of a hedge clipper comprising a lateral central handle 2 going away from a frame 1 and a rear handle 3 as well as a single-sided cutting blade 6 arranged on an attachment 4 for a drive (not shown). The drive is preferably an internal combustion engine, in particular a two-stroke internal combustion engine. The frame 1 comprises a multiply curved, substantially continuous hollow tube, one end whereof substantially forms the rear handle 3 and the other end whereof substantially forms the lateral central handle 2 of the hedge clipper.

The rear handle 3 and the lateral central handle 2 run transversely to a centre line M of the cutting blade 6. During cutting operation the hedge clipper in FIG. 1 is guided by a user with his left hand on the rear handle 3 and with his right hand on the lateral central handle 2. A hand protector 7 is provided on an end of the lateral central handle 2 facing the cutting blade 6, running completely and rotationally symmetrically around said handle, and its normal is arranged parallel to the lateral central handle 2 to protect the user's right hand from cutting residue thrown up during cutting.

A throttle lever 8 is integrated in the rear handle 3, which projects furthest from the handle in its zero-throttle position shown in FIG. 1 and during operation is pressed by the user into a recess in the rear handle 3 provided for this purpose so as to continuously increase the power of the internal combustion engine and conversely. The throttle lever 8 is connected via a control device, e.g. a Bowden cable or a control cable to the throttle flap of a carburettor located in front of the internal combustion engine and controls the power of the internal combustion engine via the angular position of the throttle flap in the gas-air mixture supply.

A brake lever 9 is integrated in the lateral central handle 2 and can be adjusted between a folded-out braking position according to FIG. 1 and a folded-in cutting position by the user exerting pressure with his right hand. In the folded-in position the brake lever 9 forms a smooth handle surface with the lateral central handle 2. The brake lever 9 is configured as elongated and cubic and in the cutting position (not shown) is arranged parallel to and in the braking position, at an angle to the lateral central handle 2. An end of the brake lever 9 facing away from the cutting blade 6 is connected to an inner wall of the lateral central handle 2 via a joint. One end of the brake lever 9 facing the cutting blade is at a distance from the lateral central handle in the braking position and during the cutting position is pressed by the right hand of the user into receptacle 5 provided in the lateral central handle 2 and thereby transferred into the cutting position.

The side view of the hedge clipper shown in FIG. 2, from the front left in FIG. 1, shows a gear housing 4 with a receptacle for the internal combustion engine provided between the rear handle 3 and the lateral central handle 2. The lateral central handle 2 and the rear handle 3 lie jointly approximately in a plane displaced parallel to a cutting plane of the cutting blade 6.

The plan view shown in FIG. 3 shows an elastic suspension of the gear housing 4 with inserted cutting blade 6 on the frame 1 on two outer and two middle springs 11. The lateral central handle 2 is provided completely laterally to and with its longitudinal direction transverse or perpendicular to the centre line 3 of the cutting blade 6. One longitudinal direction of the rear handle 3 is likewise arranged substantially perpendicular to the centre line M of the cutting blade 6 but the centre line M cuts the rear handle 3 approximately centrally.

The clutch drum 12 is embraced by a tightened brake band 13 which sits tightly thereon. The brake band 13 can be adjusted by means of a tensioning mechanism 14. One end of the brake cable 16 running in a cable guide 17 is connected to a tensioning mechanism 14 and the other end of the brake cable 16 is connected to the brake lever 9. The brake able 16 is guided through a section of the frame 1 on the cutting blade side to the lateral central handle 2.

In the rest position, the brake lever 9 pulls a brake band 13 tightly around a clutch drum 12 by means of a brake cable 16 and a tensioning mechanism 14 and thus prevents unintentional starting of the cutting blade 6 even after starting the internal combustion engine. For starting the user grips the rear handle 3 with his left hand and grips a handle (not shown) of the cable pull starter with his right hand and starts the hedge clipper. The cutting blade 6 is now locked. Even when pulling the throttle lever 8, the cutting blade 6 does not start up as long as the brake band 16 is firmly tightened. The starting brake prevents any unintentional starting of the cutting blade 6 directly after starting, which could endanger the user. Only after starting the drive does the user grip the hedge clipper on the central lateral handle 2 with his right hand and thereby presses the brake lever 9 with the ball of his hand directly into the recess 5 and thereby inactivates the starting brake. The brake band 13 is released from the clutch drum 12 and the cutting speed and power can be adjusted continuously via the throttle lever 8 using the user's left hand.

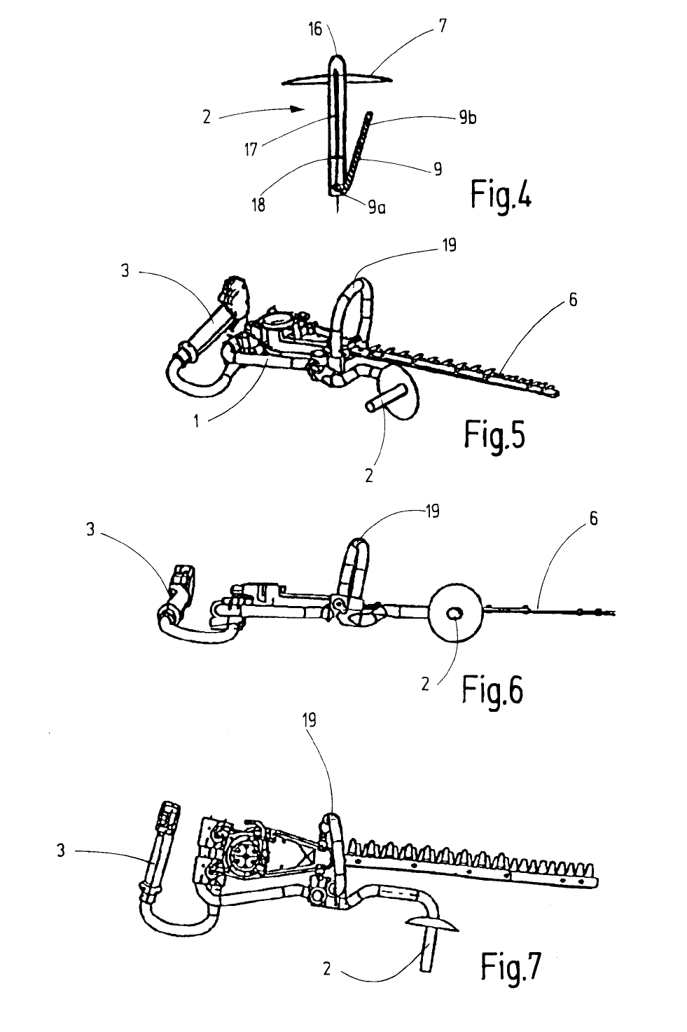

The sectional view shown in FIG. 4 shows the substantially L-shaped brake lever 9 in a cross-section in the longitudinal direction of the lateral central handle 2, with a short L-leg 9a projecting into the lateral central handle 2 and a long L-leg 9b protruding from the lateral central handle 2 in the braking position. An L-angle formed between the short and long L-legs 9a, 9b is pivotally connected via an axis of rotation to a handle inner wall via a joint.

One end of the cable guide 17 is in contact with a side of a perforated retaining plate facing the cutting blade 6 and is thus fixed at a distance with respect to the lateral central handle. The brake cable 16 runs through the hole to the short L-leg 9a. The brake cable 16 is guided in the cable guide 17. The guard plate in the form of a hand protector 7 is bent towards the central lateral handle 2.

The separate arrangement of the brake lever 9 and throttle lever 8 described in FIGS. 1-4 is also possible with regard to the brake lever in a double configuration with a hedge clipper comprising a frame 1 according to FIGS. 5, 6 and 7.

In addition to the rear handle 3, this second embodiment of the hedge clipper according to the invention has two mounted different handles 2, 19. Each of the other two handles 2, 19 can be mounted and dismounted individually. The lateral central handle 3 is configured according to the first embodiment of the invention described above. Another handle is provided in the form of a frame bow 19. Both the frame bow 19 and the lateral central handle 2 each have a brake lever (not shown). The respectively relevant brake cable 16 is guided through the frame 1 to the tensioning mechanism 14 for the brake band 13 laid around the clutch drum 12.

The frame 1 according to FIGS. 5, 6, 7 is suitable for optional use of a single-sided cutting blade 6, as shown in all the figures or a double-sided cutting blade (not shown). When a single-sided cutting blade 6 is used, the frame bow 19 is preferably dismounted in contrast to the diagram in FIGS. 5, 6 and 7 and the hedge clipper substantially has the appearance of the first embodiment. The single-sided cutting blade 6 can be replaced by a double-sided cutting blade for which a plug mechanism is provided in the gear housing 4. The double-sided hedge clipper is guided with the user's right hand on the frame bow 19 and the lateral central handle 2 is then dismounted. When dismounting/mounting the other two handles 2, 19, the brake cables 16 assigned to each of the two other handles 2, 19 should be released or installed.

Furthermore, the rear handle 3 can be pivoted from its position substantially perpendicular to the centre line M of the cutting blade 6 for the single-sided hedge clipper into a position substantially parallel to the centre line M for the double-sided hedge clipper.

1. A hand-guided work implement, in particular hedge clippers, comprising a drive having an internal combustion engine for a cutting tool and a handle for a user's hand and at least one other handle at a distance from said one handle for the other hand of the user and a throttle lever provided on one handle and capable of being actuated by the user's hand, which controls the power of the drive and at least one brake lever for a starting brake of the cutting tool which can be adjusted between a brake position and a cutting position, characterised in that the at least one brake lever is provided on the at least one other handle.

2. The hand-guided work implement according to claim 1, characterised in that the at least one brake lever occupies the braking position in its non-actuated position and the cutting position in its actuated position and in that the at least one brake lever can be transferred from the braking position to the cutting position by gripping the at least one other handle provided for correct operation by the user's other hand.

3. The hand-guided work implement according to claim 1, characterised in that the at least one brake lever is in communication with an automatic restoring mechanism.

4. The hand-guided work implement according to claim 1, characterised in that the throttle lever is connected by means of a controller which controls the angular position of a throttle flap of a carburettor for the internal combustion engine.

5. The hand-guided work implement according to claim 3, characterised in that the at least one brake lever is constructed as elongated, running along the at least one handle and projects from the at least one other handle in the braking position and in the cutting position is lowered in a recess of the at least one other handle against a restoring force the restoring mechanism.

6. The hand-guided work implement according to claim 5, characterised in that one end of the elongated at least one brake lever is connected to the at least one other handle via a joint.

7. The hand-guided work implement according to claim 6, characterised in that the handle is provided on the outside on the side of the drive facing away from the cutting tool and the at least one other handle is provided on the side of the drive facing the cutting tool transverse, in particular parallel to one another and perpendicular to the centre line (M) of the work implement.

8. The hand-guided work implement according to claim 7, characterised in that in a plan view from a user's perspective during the cutting operation onto the cutting tool, the at least one other handle is provided substantially completely to the side adjacent to the cutting tool and along the central line (M) in a central section of the work implement.

9. The hand-guided work implement according to claim 8, characterised in that the at least one lateral central handle is formed as an end section of a frame and an end of the at least one lateral central handle facing away from the cutting tool is free.

10. The hedge clipper according to claim 8, characterised in that at its end facing the cutting tool the lateral central handle has a guard plate as a hand protector arranged transversely to the lateral central handle.

11. The hand-guided work implement according to claim 7, characterised in that in a plan view from a user's perspective during the cutting operation onto the cutting tool, the at least one other handle is provided transversely to the central line (M) substantially centrally over the cutting tool.

12. The hand-guided work implement according to claim 11, characterised in that the central handle is formed as a bow whose two ends are firmly connected to the frame.

13. The hand-guided work implement according to claim 5, characterised in that the at least one other handle is removable.

14. The hand-guided work implement according to claim 1, characterised by a cable starter with a starter handle to be grasped by the user's other hand for starting the internal combustion engine.

15. The hand-guided work implement according to claim 1, characterised in that the work implement is a hedge clipper and the cutting tool is a cutting blade (6).

16. The hedge clipper according to claim 15, characterised in that as desired a single-sided cutting blade or a double-sided cutting blade can be detachably inserted in a plug mechanism of a gear housing and for single-sided operation the rear handle can be pivoted into a position transverse to the central line (M) and the at least one other handle in single-sided operation exclusively comprises the lateral central handle and for double-sided operation the rear handle can be pivoted into a position along the central line (M) and the at least one other handle exclusively comprises the bow handle.

17. The hedge clipper according to claim 16, characterised in that the at least one brake lever allocated to the bow handle and brake lever allocated to the lateral central handle each have a brake controller and both brake controllers can be detached and/or secured individually to allow dismantling and/or assembly both of the bow handle and also the lateral central handle.
